(19) United States
(12) Patent Application Publication
(10) Pub. No.: US 2026/0131638 A1
(43) Pub. Date: May 14, 2026

(54) AIR OUTLET DEVICE AND VEHICLE

(71) Applicant: ILLINOIS TOOL WORKS INC., Glenview, IL (US)

(72) Inventor: Dongming BAO, Shanghai (CN)

(21) Appl. No.: 19/381,278

(22) Filed: Nov. 6, 2025

(30) Foreign Application Priority Data
Nov. 7, 2024 (CN) 2024115809652
Oct. 31, 2025 (CN) 2025115874355

(51) Int. Cl. B60H 1/34

(52) U.S. Cl. CPC B60H 1/3421; B60H 2001/3471

(57) ABSTRACT

The present disclosure provides an air outlet device and a vehicle. The air outlet device includes a housing, a first guide element, a second guide element, a first set of vanes and a second set of vanes. The housing includes a first housing portion and a second housing portion. The first housing portion is substantially partially spherical. The first guide element is arranged in the first housing portion adjacent to the outlet and defining an annular channel connected to the outlet together with the first housing portion. The second guide element is arranged in the first housing portion adjacent to the second housing portion, and including a transverse portion and a vertical portion to define a first and a second transverse channel and a first and a second vertical channel. The first and second set of vanes are arranged in the second housing portion about a vertical axis or a transverse axis, respectively and configured to direct air into the annular channel via the vertical channel and transverse channel, respectively. The air vent device is provided with concealed vanes, preventing rotation of the vanes from interfering with the driver's operation, thereby enhancing the user experience.

### CROSS-REFERENCE TO RELATED APPLICATIONS

The present disclosure claims priority to Chinese Patent Application Nos. 202411580965.2, filed on Nov. 7, 2024, and 202511587435.5, filed on Oct. 31, 2025, each entitled “Air Outlet Device and Vehicle” and each of which is incorporated herein by reference in its entirety.

### TECHNICAL FIELD

The present disclosure relates to an air outlet device, and in particular to an air outlet device for a vehicle and a vehicle including the air outlet device.

### BACKGROUND

In an air outlet device of a ventilation system or air-conditioning system of a vehicle, a set of vanes for upward-and-downward air output and a set of vanes for leftward-and-rightward air output are provided, and the two sets of vanes rotate independently of each other to control a direction of airflow output from the air outlet device. In an air outlet device having a substantially spherical shape, the two sets of vanes are generally arranged near an airflow outlet.

### SUMMARY OF THE DISCLOSURE

The present disclosure generally relates to an air outlet device, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of an air outlet device according to a first embodiment of the present disclosure.

FIG. 1B is an exploded view of the air outlet device shown in FIG. 1A.

FIG. 2A is a front view of a second guide element of the air outlet device shown in FIG. 1A.

FIG. 2B is a perspective view of the second guide element shown in FIG. 2A from a rear perspective.

FIG. 2C is a side view of the second guide element shown in FIG. 2A.

FIG. 3A is a perspective cross-sectional view of the air outlet device shown in FIG. 1A.

FIG. 3B is an illustrative view of a first connecting section, a second connecting section, a second guide element, and a liner member in an air intake section shown in FIG. 1B in an assembled state.

FIG. 3C is an exploded view of the first connecting section, the second connecting section, the second guide element, and the liner member in the air intake section shown in FIG. 1B.

FIG. 4A is a cross-sectional view of the air outlet device shown in FIG. 1A, taken transversely and longitudinally.

FIG. 4B is an illustrative view of a first set of vanes in the air outlet device shown in FIG. 4A directing air into an annular channel via a first vertical channel.

FIG. 4C is an illustrative view of the first set of vanes in the air outlet device shown in FIG. 4A directing air into the annular channel via a second vertical channel.

FIG. 5A is a cross-sectional view of the air outlet device shown in FIG. 1A, taken vertically and longitudinally.

FIG. 5B is an illustrative view of a second set of vanes in the air outlet device shown in FIG. 5A directing air into the annular channel via a lower transverse channel.

FIG. 5C is an illustrative view of the second set of vanes in the air outlet device shown in FIG. 5A directing air into the annular channel via a upper transverse channel.

FIG. 6A is a perspective view of an air outlet device according to a second embodiment of the present disclosure.

FIG. 6B is a perspective view of the air outlet device shown in FIG. 6A with components such as a first housing portion removed.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

For ease of illustration, an XYZ coordinate system is introduced in the description and the drawings. A direction indicated by an X axis represents a transverse direction described below, a direction indicated by a Y axis represents a vertical direction described below, and a direction indicated by a Z axis represents a longitudinal direction described below.

Through long-term observation and research, it has been found that when vanes that control the airflow direction are arranged near the airflow outlet of the spherical air outlet device, they affect the overall aesthetics of the air outlet device because they are visible to the operator. In addition, since the vanes are arranged within a spherical space, the air outlet device is difficult to manufacture.

To at least partially solve the above problem, according to a first aspect of the present disclosure, the present disclosure provides an air outlet device, including a housing, a first guide element, a second guide element, a first set of vanes and a second set of vanes. The housing includes a first housing portion defining an outlet and a second housing portion defining an inlet. The first housing portion is substantially partially spherical. The first guide element is arranged in the first housing portion adjacent to the outlet and defines an annular channel connected to the outlet together with the first housing portion. The second guide element is arranged in the first housing portion adjacent to the second housing portion, and includes a transverse portion and a vertical portion intersecting with each other and extending in a transverse direction and a vertical direction of the air outlet device, respectively, to define a first transverse channel and a second transverse channel, and a first vertical channel and a second vertical channel together with the first housing portion. The first set of vanes are rotatably arranged in the second housing portion about a vertical axis and configured to direct air into the annular channel via the first vertical channel and/or the second vertical channel. The second set of vanes are rotatably arranged in the second housing portion about a transverse axis and configured to direct air into the annular channel via the first transverse channel and/or the second transverse channel.

According to a first aspect of the present disclosure, wherein an outer surface of the first guide element forms an arc-shaped first guide surface; and wherein the second guide element includes a middle guide portion, the transverse portion and the vertical portion are arranged around the middle guide portion, and the middle guide portion has a second guide surface extending continuously with the first guide surface.

According to a first aspect of the present disclosure, wherein the transverse portion, the vertical portion, and the middle guide portion of the second guide element extend by a distance in a longitudinal direction of the air outlet device.

According to a first aspect of the present disclosure, wherein respective outer surfaces of the transverse portion, the vertical portion, and the middle guide portion taper in a direction away from the outlet.

According to a first aspect of the present disclosure, wherein the transverse portion is located in the first vertical channel and the second vertical channel, and the vertical portion is located in the first transverse channel and the second transverse channel.

According to a first aspect of the present disclosure, the air outlet device further includes a partition arranged in the second housing portion so as to abut against the transverse portion of the second guide element and extending in the transverse direction and a longitudinal direction of the air outlet device to define a first additional transverse channel and a second additional transverse channel together with the second housing portion. The first additional transverse channel and the second additional transverse channel are connected to the first transverse channel and the second transverse channel, respectively. Wherein the second set of vanes is further away from the second guide element than the first set of vanes, and the second set of vanes is arranged adjacent to the partition.

According to a first aspect of the present disclosure, wherein the second set of vanes is arranged to be configured to close the first additional transverse channel or the second additional transverse channel.

According to a first aspect of the present disclosure, wherein the first set of vanes is provided with a slot for receiving the partition.

According to a first aspect of the present disclosure, wherein the second housing portion has a rectangular cross section.

According to a first aspect of the present disclosure, wherein the first housing portion includes an air output section and a first connecting section which are separated from each other. The first guide element is located in the air output section, and the second guide element is located in the first connecting section. Wherein the second housing portion includes an air intake section and a second connecting section which are separated from each other, the first set of vanes being at least partially located in the second connecting section, and the second set of vanes being located in the air intake section. Wherein the first connecting section and the second connecting section are integrally formed.

According to a first aspect of the present disclosure, wherein the transverse portion and the vertical portion of the second guide element form a cross shape to divide an inner region of the first connecting section of the first housing portion into a first sub-region, a second sub-region, a third sub-region, and a fourth sub-region. Wherein the first sub-region and the second sub-region jointly form the first transverse channel, the third sub-region and the fourth sub-region jointly form the second transverse channel, the first sub-region and the fourth sub-region jointly form the first vertical channel, and the second sub-region and the third sub-region jointly form the second vertical channel.

According to a first aspect of the present disclosure, wherein the partition includes a first partition portion, a second partition portion, and a third partition portion, the first partition portion being located in the second connecting section of the second housing portion and being integrally formed with the second connecting section, the third partition portion being located in the air intake section of the second housing portion and being integrally formed with the air intake section, and the second partition portion being located between the first partition portion and the third partition portion in the longitudinal direction of the air outlet device and being removably mounted in the air intake section.

According to a first aspect of the present disclosure, the air outlet device further includes a first driving mechanism configured to drive the first set of vanes to rotate; and a second driving mechanism configured to drive the second set of vanes to rotate.

According to a first aspect of the present disclosure, wherein the first driving mechanism is an electric motor; and the second driving mechanism is an electric motor or a mechanical adjustment device.

According to a second aspect of the present disclosure, the present disclosure provides a vehicle, including an air outlet device as aforementioned.

The present disclosure provides an air outlet device with a circular outlet, which ensures the dual-direction airflow function of the vanes while hiding them behind the guide elements. This design prevents the rotation of the vanes from distracting the driver, improves the overall aesthetics of the air outlet device, and helps prevent users from touching the vanes.

Additional aspects and advantages of the present disclosure will be partially elaborated in the following description, and will partially become apparent from the following description, or may be learned through practice of the present disclosure.

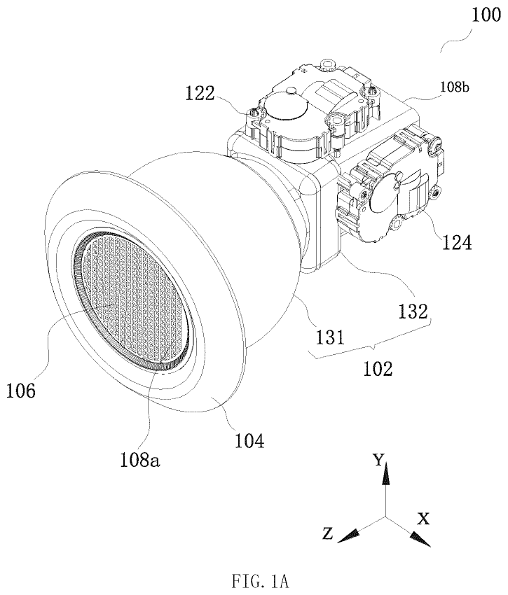

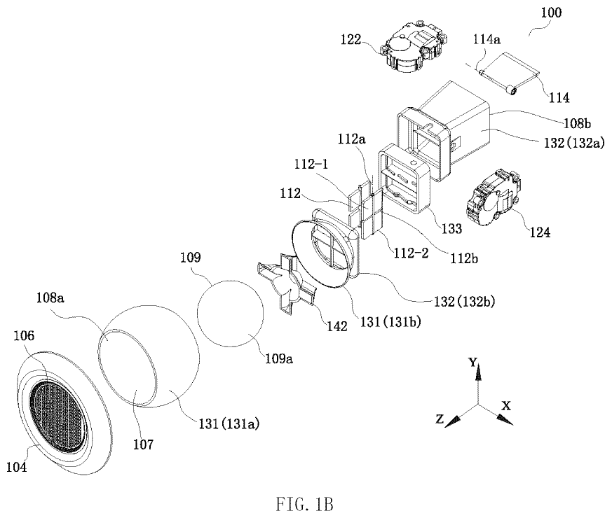

FIGS. 1A-1B show the overall structure of an air outlet device 100 according to a first embodiment of the present disclosure. FIG. 1A is a perspective view of the air outlet device 100, and FIG. 1B is an exploded view of the air outlet device 100.

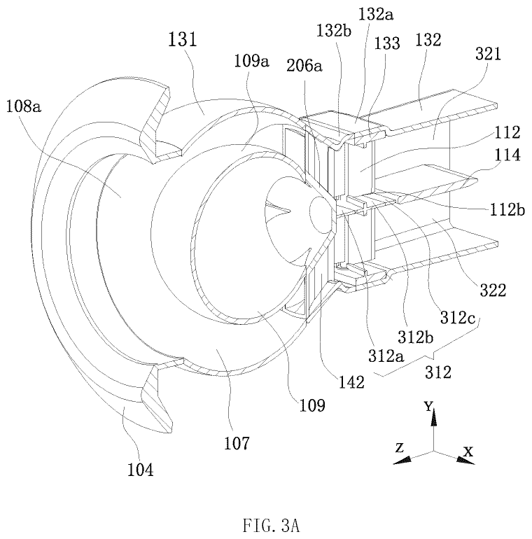

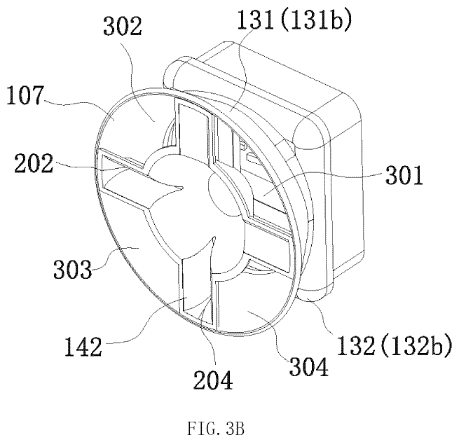

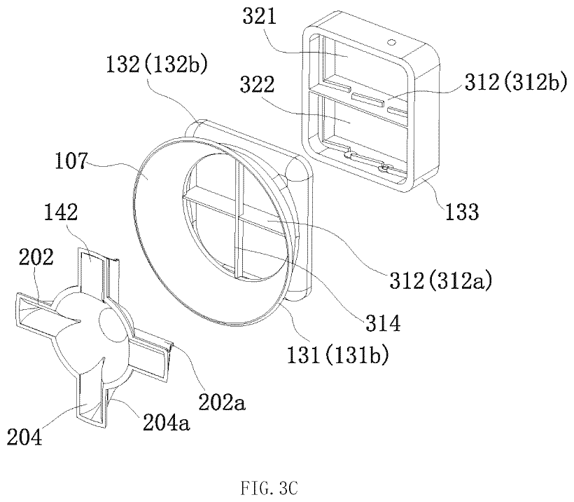

As shown in FIGS. 1A-1B, the air outlet device 100 includes a housing 102; an external panel 104; a ventilation grille 106; a first guide element 109, a second guide element 142, a first set of vanes 112 and a second set of vanes 114 arranged in the housing 102; and a first driving mechanism 122 and a second driving mechanism 124 for driving the first set of vanes 112 and the second set of vanes 114 to rotate, respectively. The housing 102 includes a first housing portion 131 defining an outlet 108a and a second housing portion 132 defining an inlet 108b. Air in the air outlet device 100 flows from the second housing portion 132 toward the first housing portion 131. The first housing portion 131 is substantially partially spherical, and the outlet 108a is substantially circular. The second housing portion 132 has a rectangular cross section. The first guide element 109 is arranged in the first housing portion 131 adjacent to the outlet 108a, and defines an annular channel 107 connected to the outlet 108a together with the first housing portion 131 (see FIG. 3A for details). An outer surface of the first guide element 109 forms an arc-shaped first guide surface 109a, and the arc-shaped first guide surface and an arc-shaped inner surface of the first housing portion 131 form an inner channel wall and an outer channel wall of the annular channel 107, respectively.

Still as shown in FIGS. 1A-1B, the second guide element 142 is arranged in the first housing portion 131 adjacent to the second housing portion 132 to define a first transverse channel (i.e. the combination of a first sub-region 301 and a second sub-region 302 in FIG. 3B) and a second transverse channel (i.e. the combination of a third sub-region 303 and a fourth sub-region 304 in FIG. 3B), and a first vertical channel (i.e., the combination of the first sub-region 301 and the fourth sub-region 304 in FIG. 3B) and a second vertical channel (i.e., the combination of the second sub-region 302 and the third sub-region 303 in FIG. 3B). In the illustrated embodiment, the second guide element 142 is arranged near an air inlet of the first housing portion 131. In addition, the first driving mechanism 122 and the second driving mechanism 124 are motors.

As shown in FIG. 1B, more specifically, the first housing portion 131 includes an air output section 131a and a first connecting section 131b which are separated from each other. The first guide element 109 is located in the air output section 131a, and the second guide element 142 is located in the first connecting section 131b. The second housing portion 132 includes an air intake section 132a and a second connecting section 132b which are separated from each other. The first set of vanes 112 is at least partially located in the second connecting section 132b, or part of the first set of vanes 112 is located in the air intake section 132a and the other part thereof is located in the second connecting section 132b. The second set of vanes 114 is located in the air intake section 132a. From a perspective of a user viewing the air outlet device 100, the first set of vanes 112 and the second set of vanes 114 are arranged behind the first guide element 109 and the second guide element 142, thereby making the first set of vanes 112 and the second set of vanes 114 concealed.

In the illustrated embodiment, the first connecting section 131b and the second connecting section 132b have circular and rectangular cross sections, respectively, and are integrally formed, thereby facilitating the transitional connection between the first housing portion 131 and the second housing portion 132. As will be appreciated by those skilled in the art, in some other embodiments, it is also possible that the first connecting section 131b is connected to the second connecting section 132b by means of snap-fit, interference fit, etc.

Still as shown in FIG. 1B, the first set of vanes 112 is rotatably arranged in the second housing portion 132 about a vertical axis 112a and is configured to direct air into the annular channel 107 via the first vertical channel and/or the second vertical channel. The second set of vanes 114 is rotatably arranged in the second housing portion 132 about a transverse axis 114a and is configured to direct air into the annular channel 107 via the first transverse channel and/or the second transverse channel. The first set of vanes 112 is provided with a slot 112b, and the slot 112b divides the first set of vanes 112 into an upper half 112-1 of the first set of vanes and a lower half 112-2 of the first set of vanes. The slot 112b is configured to receive a partition described below (see FIGS. 3A-3C for details). In the illustrated embodiment, the first set of vanes 112 includes two vanes, and the second set of vanes 114 includes one vane. As will be appreciated by those skilled in the art, in some other embodiments, it is also possible that the first set of vanes 112 and the second set of vanes 114 include other numbers of vanes.

Still as shown in FIG. 1B, the air outlet device 100 further includes a liner member 133 arranged in the air intake section 132a of the second housing portion 132 and adjacent to the second connecting section 132b for arranging the first set of vanes 112 and the above-mentioned partition.

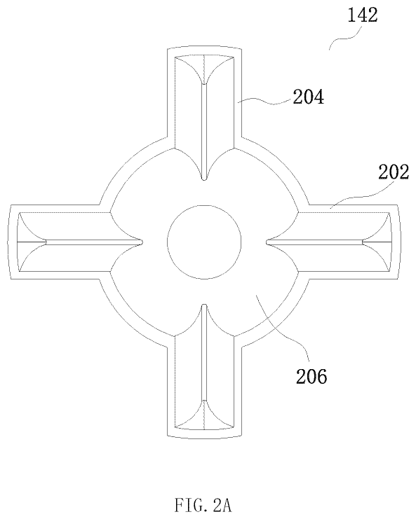

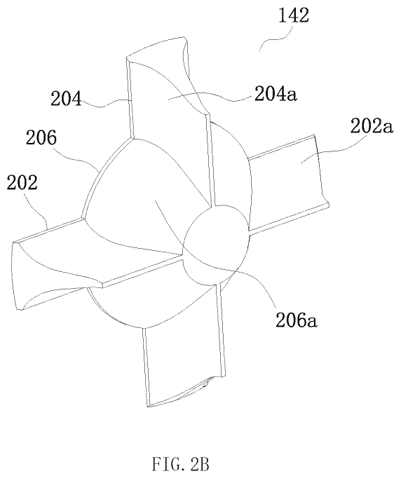

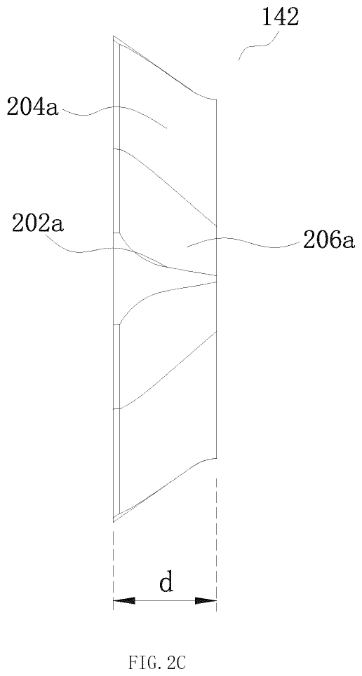

FIGS. 2A-2C show a specific structure of the second guide element 142. FIG. 2A is a front view of the second guide element 142, FIG. 2B is a perspective view of the second guide element 142 from a rear perspective, and FIG. 2C is a side view of the second guide element 142.

As shown in FIGS. 2A-2C, the second guide element 142 includes a transverse portion 202 and a vertical portion 204 intersecting with each other and extending in a transverse direction X and a vertical direction Y of the air outlet device, respectively. The transverse portion 202 and the vertical portion 204 form a cross shape to define the first transverse channel and the second transverse channel, and the first vertical channel and the second vertical channel together with the first housing portion 131. The transverse portion 202 is located in the first vertical channel and the second vertical channel, and the vertical portion 204 is located in the first transverse channel and the second transverse channel. The second guide element 142 further includes a middle guide portion 206, the transverse portion 202 and the vertical portion 204 are arranged around the middle guide portion 206, and the middle guide portion 206 has a second guide surface (outer surface) 206a extending continuously with the above-mentioned first guide surface, such that airflow flowing through the second guide element 142 can flow continuously and smoothly along the second guide surface 206a to the first guide surface.

Still as shown in FIGS. 2A-2C, the transverse portion 202, the vertical portion 204 and the middle guide portion 206 of the second guide element 142 extend by a distance d in a longitudinal direction Z of the air outlet device 100, and respective outer surfaces 202a, 204a, and 206a of the transverse portion 202, the vertical portion 204, and the middle guide portion 206 taper in a direction away from the outlet (i.e., the direction from left to right in FIG. 2C), such that the airflow flowing through the second guide element 142 can flow and diffuse along the respective outer surfaces 202a, 204a, and 206a of the transverse portion 202, the vertical portion 204, and the middle guide portion 206 toward the annular channel of the first housing portion.

FIGS. 3A-3C show components related to airflow guidance in the air outlet device. FIG. 3A is a perspective cross-sectional view of the air outlet device shown in FIG. 1A; FIG. 3B is an illustrative view of the first connecting section, the second connecting section, the second guide element, and the liner member in the air intake section shown in FIG. 1B in an assembled state; and FIG. 3C is an exploded view of the first connecting section, the second connecting section, the second guide element, and the liner member in the air intake section shown in FIG. 1B. In order to illustrate the outlet more clearly, the ventilation grille is removed in FIG. 3A.

As shown in FIGS. 3A-3C, the air outlet device further includes a partition 312 and a sealing portion 314. The partition 312 is arranged in the second housing portion 132 abutting against the transverse portion 202 of the second guide element 142 and extends in the transverse direction X and the longitudinal direction Z of the air outlet device to define a first additional transverse channel 321 and a second additional transverse channel 322 together with the second housing portion 132. The sealing portion 314 is arranged in the second connecting section 132b of the second housing portion 132 abutting against the vertical portion 204 of the second guide element 142, and serves as a longitudinal extension of the vertical portion 204 in the second housing portion 132, for forming a closed vertical channel with the first set of vanes 112 when the first set of vanes 112 is rotated. As will be appreciated by those skilled in the art that, in some other embodiments, it is also possible that no sealing portion 314 is provided. A sealing fit with the first set of vanes 112 can also be achieved only by means of the vertical portion 204 of the second guide element 142.

Still as shown in FIGS. 3A-3C, a cross-shaped structure formed by the transverse portion 202 and the vertical portion 204 of the second guide element 142 divides an inner region of the first connecting section 131b of the first housing portion into the first sub-region 301, the second sub-region 302, the third sub-region 303, and the fourth sub-region 304. The first sub-region 301 and the second sub-region 302 form the first transverse channel together, the third sub-region 303 and the fourth sub-region 304 form the second transverse channel together, the first sub-region 301 and the fourth sub-region 304 form the first vertical channel together, and the second sub-region 302 and the third sub-region 303 form the second vertical channel together. The first additional transverse channel 321 and the second additional transverse channel 322 are connected to the first transverse channel and the second transverse channel, respectively, to form an upper transverse airflow guide channel and a lower transverse airflow guide channel as shown in FIG. 3A.

Still as shown in FIGS. 3A-3C, the partition 312 includes a first partition portion 312a, a second partition portion 312b, and a third partition portion 312c. The first partition portion 312a is located in the second connecting section 132b of the second housing portion 132 and is integrally formed with the second connecting section 132b. The third partition portion 312c is located in the air intake section 132a of the second housing portion 132 and is integrally formed with the air intake section 132a. The second partition portion 312b is located between the first partition portion 312a and the third partition portion 312c in the longitudinal direction Z of the air outlet device and is removably mounted in the air intake section 132a. Specifically, in the illustrated embodiment, the second partition portion 312b is arranged on the liner member 133 and is arranged in the air intake section 132a by means of the liner member 133. As will be appreciated by those skilled in the art, in some other embodiments, it is also possible that the second partition portion 312b is integrally formed with the air intake section 132a.

Still as shown in FIGS. 3A-3C, the second set of vanes 114 is further away from the second guide element 142 than the first set of vanes 112, that is, from the perspective of the user viewing the air outlet device, the second set of vanes 114 is arranged behind the first set of vanes 112. The first set of vanes 112 is distributed on upper and lower sides of the partition 312 by the slot 112b and is arranged adjacent to the second guide element 142. The second set of vanes 114 has an axis of rotation arranged adjacent to the third partition portion 312c of the partition 312 and can close the first additional transverse channel 321 or the second additional transverse channel 322 by rotation.

Thus, by means of the partition 312, the transverse portion 202 of the second guide element 142, and the second set of vanes 114, the upper transverse airflow guide channel and the lower transverse airflow guide channel (including the first transverse channel and the second transverse channel, and the first additional transverse channel and the second additional transverse channel) are both formed in an interior of the air outlet device, and either of the upper transverse airflow guide channel and the lower transverse airflow guide channel can be selectively closed by controlling upward and downward rotation of the second set of vanes 114. By means of the vertical portion 204 of the second guide element 142, the sealing portion 314, and the first set of vanes 112, a left vertical airflow guide channel and a right vertical airflow guide channel (including the first vertical channel and the second vertical channel) are both formed in the interior of the air outlet device, and either of the left vertical channel and the right vertical channel can be selectively closed by controlling left and right rotation of the first set of vanes 112.

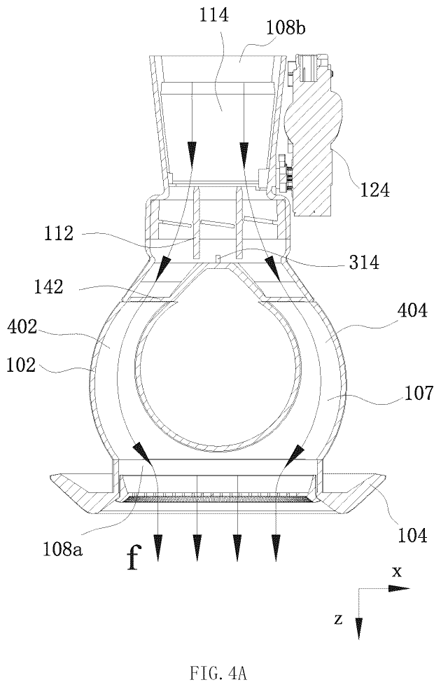

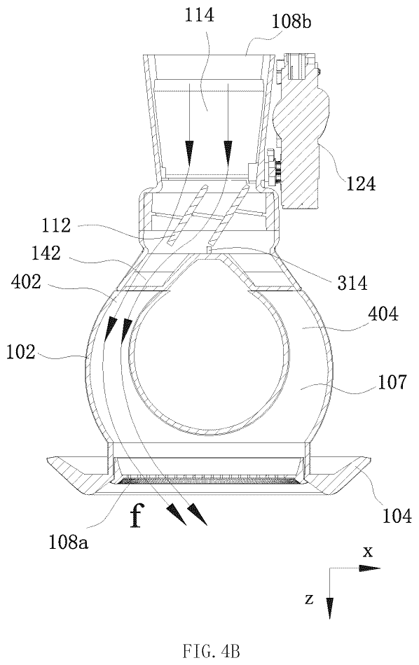

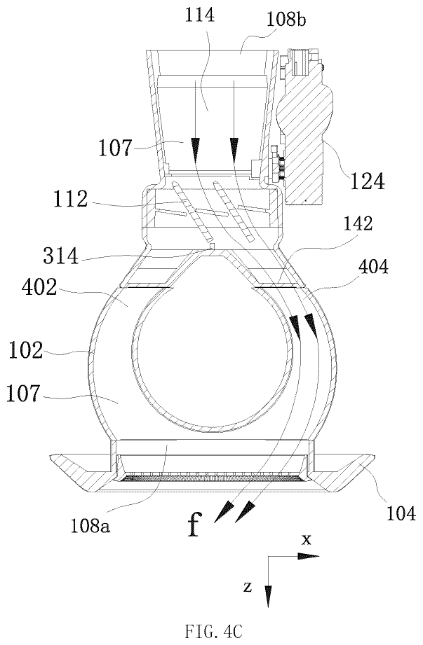

FIGS. 4A-4C show illustrative views of air flow directions when the first set of vanes of the air outlet device is in different positions. FIG. 4A is a cross-sectional view of the air outlet device shown in FIG. 1A, taken transversely and longitudinally; FIG. 4B is an illustrative view of the first set of vanes in the air outlet device shown in FIG. 4A directing air into the annular channel via the first vertical channel; and FIG. 4C is an illustrative view of the first set of vanes in the air outlet device shown in FIG. 4A directing air into the annular channel via the second vertical channel.

As shown in FIGS. 4A-4C, when the second set of vanes 114 is in a neutral position, the air outlet device 100 may have a first air output state, a second air output state, and a third air output state.

As shown in FIG. 4A, when the first driving mechanism drives the first set of vanes 112 to rotate to the neutral position, the air outlet device 100 is in the first air output state, in which airflow f flowing into the housing 102 uniformly flows out from the left vertical channel 402 and the right vertical channel 404 in a direction indicated by arrows shown in the figure, thereby giving the user a feeling that the airflow f blows forward.

As shown in FIG. 4B, when the first driving mechanism drives the first set of vanes 112 to rotate to a left position, the air outlet device 100 is in the second air output state, in which a right vane of the first set of vanes 112 comes into contact with and fits against the sealing portion 314 and the housing 102, thereby closing the right vertical channel 404 and causing the airflow f to pass only through the left vertical channel 402. The flow direction of the airflow f is changed under the guidance of the annular channel 107, such that the airflow f finally flows out towards the right from the outlet 108a, thereby giving the user a feeling that the airflow f blows towards the right.

As shown in FIG. 4C, when the first driving mechanism drives the first set of vanes 112 to rotate to a right position, the air outlet device 100 is in the third air output state, in which a left vane of the first set of vanes 112 comes into contact with and fits against the sealing portion 314 and the housing 102, thereby closing the left vertical channel 402 and causing the airflow f to pass only through the right vertical channel 404. The flow direction of the airflow f is changed under the guidance of the annular channel 107, such that the airflow f finally flows out towards the left from the outlet 108a, thereby giving the user a feeling that the airflow f blows towards the left.

As will be appreciated by those skilled in the art, the first driving mechanism also drives the first set of vanes 112 to rotate to a position parallel to the transverse direction, thereby closing both the left vertical channel 402 and the right vertical channel 404. In this case, no airflow flows out of the outlet 108a, and the air outlet device is in a closed state.

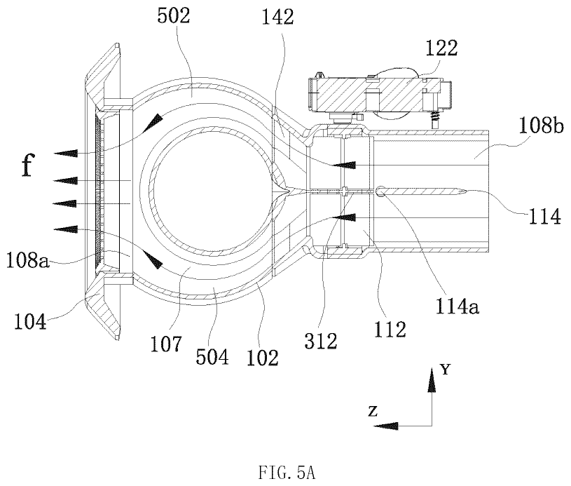

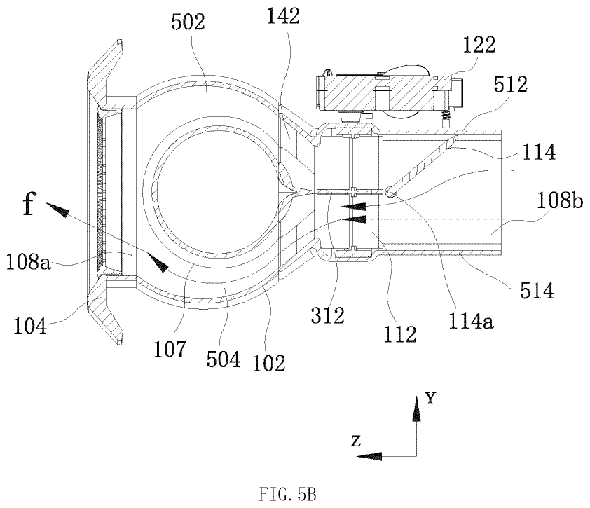

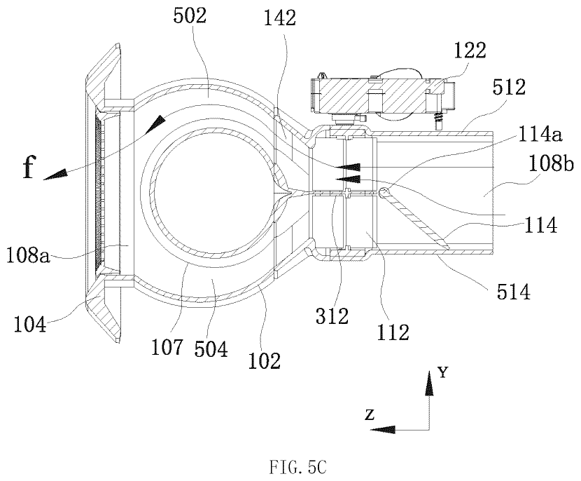

FIGS. 5A-5C show illustrative views of air flow directions when the second set of vanes of the air outlet device is in different positions. FIG. 5A is a cross-sectional view of the air outlet device shown in FIG. 1A, taken vertically and longitudinally; FIG. 5B is an illustrative view of the second set of vanes in the air outlet device shown in FIG. 5A directing air into the annular channel via the lower transverse channel; and FIG. 5C is an illustrative view of the second set of vanes in the air outlet device shown in FIG. 5A directing air into the annular channel via the upper transverse channel.

As shown in FIGS. 5A-5C, when the first set of vanes 112 is in the neutral position, the air outlet device 100 may have a fourth air output state, a fifth air output state, and a sixth air output state.

As shown in FIG. 5A, when the second driving mechanism drives the second set of vanes 114 to rotate to the neutral position, the airflow f flowing into the housing 102 uniformly flows out from the upper transverse channel 502 and the lower transverse channel 504 in a direction indicated by arrows shown in the figure, thereby giving the user a feeling that the airflow f blows forward.

As shown in FIG. 5B, when the second driving mechanism drives the second set of vanes 114 to rotate to an upper position, the second set of vanes 114 comes into contact with and fits against an upper side wall 512 of the housing 102, thereby closing the upper transverse channel 502, and causing the airflow f to pass only through the lower transverse channel 504. The flow direction of the airflow f is changed under the guidance of the annular channel 107, such that the airflow f finally flows out upward from the outlet 108a, thereby giving the user a feeling that the airflow f blows upward.

As shown in FIG. 5C, when the second driving mechanism drives the second set of vanes 114 to rotate to a lower position, the second set of vanes 114 comes into contact with and fits against a lower side wall 514 of the housing 102, thereby closing the lower transverse channel 504, and causing the airflow f to pass only through the upper transverse channel 502. The flow direction of the airflow f is changed under the guidance of the annular channel 107, such that the airflow f finally flows out downward from the outlet 108a, thereby giving the user a feeling that the airflow f blows downward.

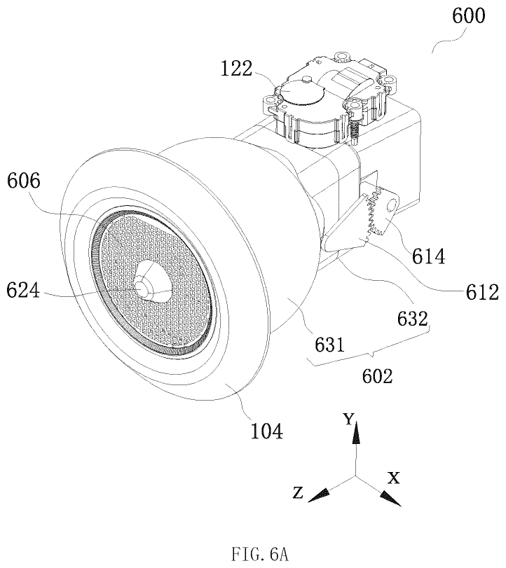

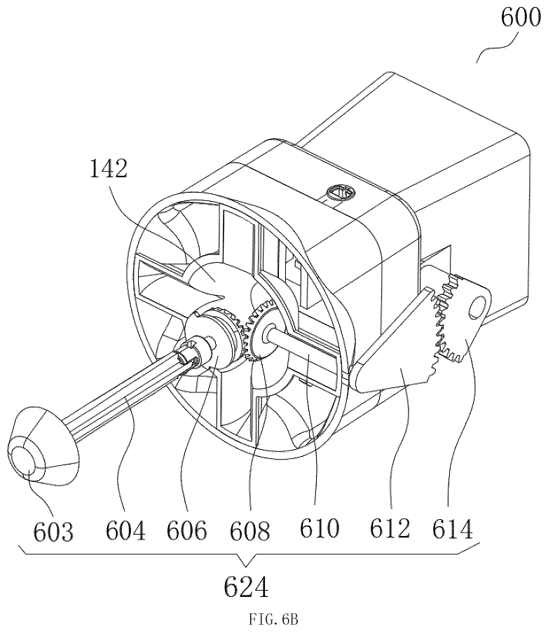

FIGS. 6A-6B show a specific structure of a second embodiment of the air outlet device of the present disclosure. FIG. 6A is a perspective view of an air outlet device according to a second embodiment of the present disclosure; FIG. 6B is a perspective view of the air outlet device shown in FIG. 6A with components such as a first housing portion removed, so as to show a specific structure of a mechanical adjustment device.

The second embodiment of the present disclosure differs from the first embodiment in that the second driving mechanism is different. The second driving mechanism in the first embodiment is a motor or an actuator, such that the air direction of the air outlet device is fully electrically adjusted. Through long-term observation and research, it has been found that user demand for the upward-and-downward air output adjustment is much lower than that for the leftward-and-rightward air output, so that the second driving mechanism remains in an idle state for most of the time. For the purpose of reducing the volume and the cost, the second driving mechanism is configured as a mechanical adjustment device in the second embodiment, and the same parts will not be described again.

As shown in FIGS. 6A-6B, in the second embodiment, part of a second driving mechanism 624 of an air outlet device 600 extends to a side of the external panel 104 that is visually visible. Specifically, the second driving mechanism 624 includes an adjustment knob 603, a transmission rod 604, and a gear transmission assembly 606, 608, 610, 612, 614. Part of the gear transmission assembly is arranged in a first housing portion 631 of a housing 602, and another part of the gear transmission assembly extends from the first housing portion 631 to the outside of the housing 602 and is connected to a rotating shaft of the second set of vanes 114 through the second housing portion 632. The adjustment knob 603 extends to the outside of the ventilation grille 606 by means of the transmission rod 604 to be in a position convenient for the user to adjust. The transmission rod 604 connects the adjustment knob 603 and the gear transmission assembly, to enable rotation of the adjustment knob 603 to be converted into rotation of the second set of vanes 114.

The present disclosure further sets forth a vehicle, including the air outlet device 100/600 of the first embodiment or the second embodiment described above.

In the air outlet device of the present disclosure, a space in the partially spherical housing portion defining the outlet is divided into two parts of space. The first guide element is arranged in one part of space close to the outlet to form the annular channel, and the second guide element is arranged in the other part of space away from the outlet to form two transverse channels and two vertical channels, such that the first set of vanes and the second set of vanes can be arranged outside the spherical housing portion, while enabling the guide control of the air flow direction by the first set of vanes and the second set of vanes. Since the first set of vanes and the second set of vanes are arranged outside the spherical housing portion defining the outlet, the first set of vanes and the second set of vanes are concealed and invisible to an operator, while the first set of vanes and the second set of vanes can be in the form of existing vanes. Therefore, the air outlet device of the present disclosure is easier to manufacture while having a good visual effect.

Although the present disclosure is described with reference to the examples of the embodiments, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting; therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or substantial equivalents.

### LIST OF REFERENCE SIGNS

Air Outlet Device 100/600
Housing 102/602
External Panel 104
Ventilation Grille 106
Annular Channel 107
Outlet 108a
Inlet 108b
First Guide Element 109
First Guide Surface 109a
First Set Of Vanes 112
Upper Half 112-1 Of First Set Of Vanes
Lower Half 112-2 Of First Set Of Vanes
Slot 112b
Second Set Of Vanes 114
First Driving Mechanism 122
Second Driving Mechanism 124/624
First Housing Portion 131/631
Air Output Section 131a
First Connecting Section 131b
Second Housing Portion 132/632
Air Intake Section 132a
Second Connecting Section 132b
Liner Member 133
Second Guide Element 142
Transverse Portion 202
Outer Surface 202a Of Transverse Portion
Vertical Portion 204
Outer Surface 204a Of Vertical Portion
Middle Guide Portion 206
Second Guide Surface 206a
First Sub-Region 301
Second Sub-Region 302
Third Sub-Region 303
Fourth Sub-Region 304
Partition 312
First Partition Portion 312a
Second Partition Portion 312b
Third Partition Portion 312c
Sealing Portion 314
First Additional Transverse Channel 321
Second Additional Transverse Channel 322
Left Vertical Channel 402
Right Vertical Channel 404
Upper Transverse Channel 502
Lower Transverse Channel 504
Upper Side Wall 512
Lower Side Wall 514
Adjustment Knob 603
Transmission Rod 604
Gear Transmission Assembly 606, 608, 610, 612, 614

1. An air outlet device, comprising:
a housing comprising a first housing portion defining an outlet and a second housing portion defining an inlet, the first housing portion being substantially partially spherical;
a first guide element arranged in the first housing portion adjacent to the outlet and defining an annular channel connected to the outlet together with the first housing portion;
a second guide element arranged in the first housing portion adjacent to the second housing portion, and comprising a transverse portion and a vertical portion intersecting with each other and extending in a transverse direction and a vertical direction of the air outlet device, respectively, to define a first transverse channel and a second transverse channel, and a first vertical channel and a second vertical channel together with the first housing portion;
a first set of vanes rotatably arranged in the second housing portion about a vertical axis and configured to direct air into the annular channel via the first vertical channel and/or the second vertical channel; and
a second set of vanes rotatably arranged in the second housing portion about a transverse axis and configured to direct air into the annular channel via the first transverse channel and/or the second transverse channel.

2. The air outlet device of claim 1, wherein
an outer surface of the first guide element forms an arc-shaped first guide surface; and
wherein the second guide element comprises a middle guide portion, the transverse portion and the vertical portion are arranged around the middle guide portion, and the middle guide portion has a second guide surface extending continuously with the first guide surface.

3. The air outlet device of claim 2, wherein
the transverse portion, the vertical portion, and the middle guide portion of the second guide element extend by a distance in a longitudinal direction of the air outlet device.

4. The air outlet device of claim 3, wherein
respective outer surfaces of the transverse portion, the vertical portion, and the middle guide portion taper in a direction away from the outlet.

5. The air outlet device of claim 1, wherein
the transverse portion is located in the first vertical channel and the second vertical channel, and the vertical portion is located in the first transverse channel and the second transverse channel.

6. The air outlet device of claim 2, further comprising:
a partition arranged in the second housing portion so as to abut against the transverse portion of the second guide element and extending in the transverse direction and a longitudinal direction of the air outlet device to define a first additional transverse channel and a second additional transverse channel together with the second housing portion, the first additional transverse channel and the second additional transverse channel being connected to the first transverse channel and the second transverse channel, respectively;
wherein the second set of vanes is further away from the second guide element than the first set of vanes, and the second set of vanes is arranged adjacent to the partition.

7. The air outlet device of claim 6, wherein
the second set of vanes is arranged to be configured to close the first additional transverse channel or the second additional transverse channel.

8. The air outlet device of claim 6, wherein
the first set of vanes is provided with a slot for receiving the partition.

9. The air outlet device of claim 6, wherein
the second housing portion has a rectangular cross section.

10. The air outlet device of claim 9, wherein
the first housing portion comprises an air output section and a first connecting section which are separated from each other, the first guide element being located in the air output section, and the second guide element being located in the first connecting section; and
wherein the second housing portion comprises an air intake section and a second connecting section which are separated from each other, the first set of vanes being at least partially located in the second connecting section, and the second set of vanes being located in the air intake section;
wherein the first connecting section and the second connecting section are integrally formed.

11. The air outlet device of claim 10, wherein
the transverse portion and the vertical portion of the second guide element form a cross shape to divide an inner region of the first connecting section of the first housing portion into a first sub-region, a second sub-region, a third sub-region, and a fourth sub-region; and
wherein the first sub-region and the second sub-region jointly form the first transverse channel, the third sub-region and the fourth sub-region jointly form the second transverse channel, the first sub-region and the fourth sub-region jointly form the first vertical channel, and the second sub-region and the third sub-region jointly form the second vertical channel.

12. The air outlet device of claim 10, wherein
the partition comprises a first partition portion, a second partition portion, and a third partition portion, the first partition portion being located in the second connecting section of the second housing portion and being integrally formed with the second connecting section, the third partition portion being located in the air intake section of the second housing portion and being integrally formed with the air intake section, and the second partition portion being located between the first partition portion and the third partition portion in the longitudinal direction of the air outlet device and being removably mounted in the air intake section.

13. The air outlet device of claim 1, further comprising:
a first driving mechanism configured to drive the first set of vanes to rotate; and
a second driving mechanism configured to drive the second set of vanes to rotate.

14. The air outlet device of claim 13, wherein
the first driving mechanism is a motor; and
the second driving mechanism is a motor or a mechanical adjustment device.

15. A vehicle comprising an air outlet device of claim 1.
